(19) United States
(12) Patent Application Publication
(10) Pub. No.: US 2026/0368581 A1
(43) Pub. Date: Nov. 19, 2026

(54) FASTER GROUND STATE ENERGY ESTIMATION ON EARLY FAULT-TOLERANT QUANTUM COMPUTERS VIA REJECTION SAMPLING

(71) Applicant: Zapata Computing, Inc., Boston, MA (US)

(72) Inventors: Guoming Wang, North York (CA); Peter Johnson, Portland, ME (US); Daniel França, Lyon (FR); Jesus Guarmo Rendón Suzuki, Woodside, NY (US)

(21) Appl. No.: 18/637,948

(22) Filed: Apr. 17, 2024

Related U.S. Application Data
(60) Provisional application No. 63/496,890, filed on Apr. 18, 2023.

(51) Int. Cl. G06N 10/20; G06N 10/60

(52) U.S. Cl. CPC G06N 10/20; G06N 10/60

(57) ABSTRACT

The present invention relates to a method for estimating the ground state energy of a physical system using a hybrid quantum-classical computer. This innovative approach involves a process where the physical system is first encoded into a quantum Hamiltonian on the classical component of the computer. A coarse estimate of the system's energy is then generated on the quantum component by applying an encoding model to the quantum Hamiltonian. This coarse estimate is subsequently refined into a more precise estimate through the use of quantum rejection sampling, also on the quantum component. The encoding model utilized in this method can vary, with options including a Hamiltonian evolution model or a block encoding model. The refinement process leverages quantum eigenvalue transformation of unitary matrices with real polynomials, which is particularly advantageous for early fault-tolerant quantum computers that face limitations in qubit numbers and operational complexity.

### CROSS-REFERENCE TO RELATED APPLICATIONS

This application claims the benefit of U.S. Prov. Pat. App. No. 63/496,890, filed on Apr. 18, 2023, entitled, “Faster Ground State Energy Estimation On Early Fault-Tolerant Quantum Computers Via Rejection Sampling,” which is hereby incorporated by reference herein in its entirety.

### BACKGROUND

Quantum computing has emerged as a transformative technology with the potential to solve complex problems that are intractable for classical computers. One of the most promising applications of quantum computing is in the field of quantum chemistry, where it can be used to simulate the properties of molecules and materials at the quantum level. A fundamental challenge in quantum chemistry is the estimation of the ground state energy of a quantum Hamiltonian, which describes the lowest energy state of a physical system. Accurate ground state energy estimation is crucial for understanding chemical reactions, designing new materials, and discovering drugs.

The prior art in ground state energy estimation (GSEE) can be broadly categorized into two approaches: methods assuming a fault-tolerance cost model and methods assuming a pre-fault-tolerance cost model. The fault-tolerance cost model is based on the assumption that quantum error correction techniques can be used to reduce the error rates of quantum operations, allowing for the execution of long quantum circuits. Under this model, quantum phase estimation (QPE) algorithms have been developed, which require the preparation of an initial state with a non-trivial overlap with the ground state and the implementation of a time evolution operator for a duration inversely proportional to the desired precision. While these algorithms can provide rigorous performance guarantees, they demand a large number of quantum gates and deep circuits, which are beyond the capabilities of near-term quantum devices.

On the other hand, the pre-fault-tolerance cost model is tailored to near-term, noisy intermediate-scale quantum (NISQ) devices, which are limited by fixed error rates and a finite number of quantum operations per circuit. The variational quantum eigensolver (VQE) is a representative algorithm of this approach, which uses a parameterized quantum circuit to approximate the ground state. VQE is more amenable to implementation on NISQ devices but lacks the performance guarantees of QPE algorithms. The accuracy of VQE depends on the expressiveness of the variational ansatz and the ability to solve an associated non-convex optimization problem, which can be challenging and time-consuming.

Both approaches have limitations that hinder their practical application. The fault-tolerance cost model is not yet realizable with current quantum technology, and the pre-fault-tolerance cost model does not provide the accuracy and guarantees needed for reliable GSEE. There is a need for methods that can estimate ground state energies with fewer operations per circuit and that are suitable for early fault-tolerant quantum computers, which represent an intermediate stage between NISQ devices and fully fault-tolerant quantum computers. Such early fault-tolerant quantum computers are expected to have a limited number of logical qubits and a limited ability to execute controlled operations, with maximum circuit depths determined by the coherence time of the qubits.

The limitations of the prior art highlight the need for new quantum algorithms that can efficiently estimate ground state energies on quantum computers that are constrained by the number of operations they can perform.

### SUMMARY

The present invention relates to a method for estimating the ground state energy of a physical system using a hybrid quantum-classical computer. This innovative approach involves a process where the physical system is first encoded into a quantum Hamiltonian on the classical component of the computer. A coarse estimate of the system's energy is then generated on the quantum component by applying an encoding model to the quantum Hamiltonian. This coarse estimate is subsequently refined into a more precise estimate through the use of quantum rejection sampling, also on the quantum component.

The encoding model utilized in this method can vary, with options including a Hamiltonian evolution model or a block encoding model. The refinement process leverages quantum eigenvalue transformation of unitary matrices with real polynomials, which is particularly advantageous for early fault-tolerant quantum computers that face limitations in qubit numbers and operational complexity.

This method is significant as it offers a way to perform complex quantum computations with improved efficiency and reduced resource requirements. It is especially beneficial for early-stage quantum computers, providing a practical solution for estimating ground state energies, which is a fundamental problem in various scientific fields such as condensed matter physics, quantum chemistry, and material science.

Other features and advantages of various aspects and embodiments of the present invention will become apparent from the following description and from the claims.

### BRIEF DESCRIPTION OF THE DRAWINGS

FIG. 1 is a diagram of a quantum computer according to one embodiment of the present invention;

FIG. 2A is a flowchart of a method performed by the quantum computer of FIG. 1 according to one embodiment of the present invention;

FIG. 2B is a diagram of a hybrid quantum-classical computer which performs quantum annealing according to one embodiment of the present invention; and

FIG. 3 is a diagram of a hybrid quantum-classical computer according to one embodiment of the present invention.

FIG. 4 is a flowchart of a method performed by one embodiment of the present invention.

### DETAILED DESCRIPTION

The present invention relates to a method for estimating the ground state energy of a physical system using a hybrid quantum-classical computer. This innovative approach involves a process where the physical system is first encoded into a quantum Hamiltonian on the classical component of the computer. A coarse estimate of the system's energy is then generated on the quantum component by applying an encoding model to the quantum Hamiltonian. This coarse estimate is subsequently refined into a more precise estimate through the use of quantum rejection sampling, also on the quantum component.

The encoding model utilized in this method can vary, with options including a Hamiltonian evolution model or a block encoding model. The refinement process leverages quantum eigenvalue transformation of unitary matrices with real polynomials, which is particularly advantageous for early fault-tolerant quantum computers that face limitations in qubit numbers and operational complexity.

This method is significant as it offers a way to perform complex quantum computations with improved efficiency and reduced resource requirements. It is especially beneficial for early-stage quantum computers, providing a practical solution for estimating ground state energies, which is a fundamental problem in various scientific fields such as condensed matter physics, quantum chemistry, and material science.

The encoding of a physical system into a quantum Hamiltonian is one step in the process of estimating the ground state energy of the system using a hybrid quantum-classical computer. This encoding serves as the bridge between the classical description of the physical system, which may include molecular structures, atomic configurations, or condensed matter systems, and the quantum representation that is necessary for quantum computation.

The purpose of this encoding is to translate the classical information about the physical system into a form that can be processed by the quantum component of the hybrid computer. The quantum Hamiltonian thus created encapsulates the energy landscape of the system, including its ground state, which the quantum computer will subsequently estimate.

To implement this encoding, the classical component of the hybrid computer may employ various computational techniques that are chosen based on the nature of the physical system under consideration. The following are some of the methods that can be used to perform this encoding:
Basis Set Selection: The first step in encoding is often the selection of an appropriate basis set to represent the wavefunctions of the electrons in the system. The choice of basis set, such as Gaussian-type orbitals or plane waves, depends on the type of physical system and the level of accuracy required.
Electronic Structure Methods: Once a basis set is chosen, electronic structure methods are used to approximate the interactions within the physical system. These methods may include the Hartree-Fock method, density functional theory (DFT), or post-Hartree-Fock methods such as configuration interaction (CI) or coupled-cluster theory.
Second-Quantization Representation: The Hamiltonian may be transformed into a second-quantized representation, which expresses the Hamiltonian in terms of creation and annihilation operators. This form is particularly amenable to further processing by quantum algorithms.
Mapping Techniques: To convert the fermionic operators present in the second-quantized Hamiltonian into qubit operators, mapping techniques such as the Jordan-Wigner transformation, Bravyi-Kitaev transformation, or parity mapping are applied.
Symmetry Considerations: The classical component may also incorporate symmetry considerations to simplify the quantum Hamiltonian. By exploiting symmetries, the number of terms in the Hamiltonian can be reduced, leading to a more efficient quantum computation.
Term Reduction: The classical component may perform a pre-processing step to identify and remove terms from the quantum Hamiltonian that have a negligible impact on the ground state energy. This optimization step can significantly reduce the complexity of the quantum computation.
Error Mitigation: Prior to its use in the quantum component, the classical component may apply error mitigation techniques to the quantum Hamiltonian to account for potential computational errors.
Optimization for Quantum Hardware: Finally, the classical component may optimize the quantum Hamiltonian to align with the connectivity and gate set available on the quantum component. This optimization ensures that the encoded Hamiltonian can be efficiently processed by the quantum computer.

The encoding process is a collaborative effort between the classical and quantum components, where the classical component performs the necessary computations and optimizations to prepare the quantum Hamiltonian for the quantum estimation of the ground state energy.

Generating a coarse estimate of the energy of a physical system on the quantum component precedes the refinement of this estimate to approach the true ground state energy. The coarse estimate serves as an initial approximation, providing a starting point for further quantum computations aimed at honing in on the ground state energy with greater precision. Also incorporated by reference herein is the following paper: “Ground state preparation and energy estimation on early fault-tolerant quantum computers via quantum eigenvalue transformation of unitary matrices,” Yulong Dong et al., April 12, 2022, available online at https://arxiv.org/abs/2204.05955.

The process of generating a coarse estimate involves the application of an encoding model to the quantum Hamiltonian, which has been previously encoded on the classical component of the hybrid quantum-classical computer. This encoding model is a quantum algorithm or a set of quantum operations that translates the quantum Hamiltonian into a form from which an energy estimate can be derived.

Any of a variety of techniques may be used to generate a coarse estimate, such as any one or more of the following, in any combination:
Variational Quantum AlgorithmsThe quantum component may utilize variational quantum algorithms, such as the Variational Quantum Eigensolver (VQE), which employ parameterized quantum circuits to prepare trial wavefunctions. These wavefunctions are iteratively adjusted to minimize the expectation value of the quantum Hamiltonian, leading to a coarse estimate of the ground state energy.
Quantum Phase Estimation (QPE)For systems where a good initial guess of the ground state is available, the quantum phase estimation algorithm can be applied to determine the phase corresponding to the eigenvalue of the quantum Hamiltonian, providing a coarse estimate of the energy.
Quantum Eigenvalue Transformation (QET-U)As highlighted in the "Disclosure" document, the invention may incorporate a quantum eigenvalue transformation of unitary matrices with real polynomials (QET-U). This technique is particularly suited for early fault-tolerant quantum devices and involves querying the time evolution operator of the Hamiltonian to prepare a state from which the coarse energy estimate can be extracted.
Hamiltonian Simulation TechniquesThe quantum component may implement Hamiltonian simulation techniques, such as Trotter-Suzuki decomposition, to approximate the time evolution operator of the quantum Hamiltonian. This approximation is used to generate the coarse energy estimate.
Measurement-Based SamplingThe quantum component can perform a series of measurements to sample from the probability distribution defined by the quantum Hamiltonian's eigenstates. The results of these measurements contribute to the coarse estimate of the energy.
Hybrid Quantum-Classical LoopsIn some embodiments, the quantum component may be part of a hybrid loop, where it performs quantum measurements, and the classical component processes these measurements to update the parameters of the quantum circuit, thereby refining the coarse energy estimate.

The generation of a coarse estimate is a quantum process that leverages the superposition and entanglement capabilities of the quantum component. It is a precursor to the more detailed and accurate energy estimations that follow. Techniques employed by embodiments of the present invention may be used to ensure that the coarse estimate is obtained efficiently and is tailored for early fault-tolerant quantum devices, setting the stage for the subsequent refinement steps that lead to the precise determination of the ground state energy.

The refinement of a coarse estimate of the energy of a physical system into a refined estimate leverages the quantum component's capabilities. This refinement process is designed to enhance the precision of the energy estimate, bringing it closer to the true ground state energy of the system, which is of paramount importance in quantum simulations and computations.

The refinement may be achieved through a process we refer to as quantum rejection sampling, a quantum computational technique that iteratively evaluates and selectively accepts or rejects energy samples based on their contribution to the accuracy of the energy estimate. This method is akin to a filtering process where only the most relevant samples, which are indicative of the ground state energy, are retained for the final estimation. Quantum rejection sampling is described in, for example, “Faster ground state energy estimation on early fault-tolerant quantum computers via rejection sample,” Guoming Wang et al., April 19, 2023, available online at https://arxiv.org/abs/2304.09827v1, which is hereby incorporated by reference herein.

As described therein, quantum rejection sampling involves using a quantum computer to facilitate rejection sampling, where a classical computer is used to draw samples and the quantum computer is then used to accept or reject the samples. This approach can provide a quadratic improvement on the ground state overlap parameter compared to other methods, when applied to the problem of ground state energy estimation on early fault-tolerant quantum computers. The paper cited above also introduces a second algorithm that can certify that the estimated ground state energy is within a specified error tolerance of the true ground state energy, addressing the issue of gap estimation that has been a challenge for some ground state preparation and energy estimation algorithms. Overall, quantum rejection sampling represents an innovative way to leverage the capabilities of quantum computers to improve the efficiency of important quantum algorithms, even on early fault-tolerant devices with operational constraints.

Refinement may be performed combining a variety of techniques, such as any one or more of the following, in any combination:
Iterative Sampling and Filtering: The quantum component performs iterative sampling of energy values from the probability distribution defined by the quantum Hamiltonian. Each sample is evaluated against a set of criteria or a threshold that is dynamically adjusted based on the coarse estimate. Samples that meet the criteria are accepted, contributing to the refined estimate, while others are rejected.
Ancilla-Assisted Acceptance Probability Encoding: An ancillary qubit system may be employed to encode the acceptance probabilities for each sampled energy value. The probabilities are functions of the difference between the sampled energies and the coarse estimate, and the ancillary system is used to measure the acceptance of each sample.
Quantum Circuit Parameter Feedback: The quantum rejection sampling process may include a feedback mechanism where the parameters of the quantum circuit are updated in real-time based on the distribution of the sampled energies. This feedback loop ensures that the sampling process becomes more focused and efficient as the refinement progresses.
Amplitude Amplification Integration: To increase the efficiency of the sampling process, amplitude amplification techniques can be integrated into the quantum rejection sampling. This integration serves to enhance the probability of sampling energy values that are close to the coarse estimate, thereby expediting the convergence to the refined estimate.
Post-Selection and Normalization: After the sampling process, a post-selection step is implemented where only the measurement outcomes corresponding to the lower energy spectrum of the quantum Hamiltonian are retained. A subsequent normalization step adjusts the weights of the accepted samples to correct for any biases introduced during the sampling process.
Hybrid Optimization: In conjunction with the quantum rejection sampling, a classical optimization algorithm may analyze the distribution of sampled energies and guide the quantum component in selecting the most informative samples for inclusion in the refined estimate.

The refinement process is a distinctive aspect of the invention that capitalizes on the probabilistic nature of quantum measurements to iteratively home in on an accurate estimate of the ground state energy. This process is particularly advantageous for early fault-tolerant quantum computers, where the balance between computational resources and precision is crucial. The unique methods of implementation as disclosed ensure that the refined estimate is obtained with a high degree of accuracy and efficiency, which are useful for the practical application of quantum computing in solving complex physical problems.

The encoding model may be a Hamiltonian evolution model. The Hamiltonian evolution model is a representation of the quantum system's dynamics, where the time evolution of the system is governed by the Schrödinger equation. In the context of the embodiments of the present invention, the Hamiltonian evolution model serves as the encoding model that translates the physical properties of the system into a quantum algorithm that can be executed on a quantum computer.

One purpose of employing a Hamiltonian evolution model as the encoding model is to leverage the natural evolution of quantum states under the system's Hamiltonian to facilitate the estimation of the ground state energy. This approach aligns with the fundamental principles of quantum mechanics and allows for a direct and intuitive mapping from the physical system to the quantum computational framework.

Benefits of the Hamiltonian evolution model include the following:
Fidelity to Physical Dynamics: The Hamiltonian evolution model accurately captures the true dynamics of the quantum system, ensuring that the quantum computations are closely aligned with the physical behavior of the system.
Efficient Utilization of Quantum Resources: By using the system's natural time evolution, the Hamiltonian evolution model can often simplify the quantum circuits required for simulation, leading to more efficient use of quantum resources.
Scalability: The Hamiltonian evolution model is inherently scalable, as it can be applied to systems of varying sizes and complexities without the need for significant modifications to the underlying quantum algorithms.
Compatibility with Quantum Algorithms: This model is compatible with a range of quantum algorithms, including those designed for fault-tolerant quantum computers, making it a versatile choice for implementing the method of claim 1.
Enhanced Precision: When combined with quantum rejection sampling, the Hamiltonian evolution model allows for the iterative refinement of energy estimates, leading to enhanced precision and accuracy in the determination of the ground state energy.
Simplification of Quantum Operations: The use of the Hamiltonian evolution model can simplify the quantum operations required for encoding and simulation, as it often involves the application of time-evolution operators that are native to quantum systems.

Embodiments of the present invention may employ quantum eigenvalue transformation of unitary matrices with real polynomials (QET-U) to generate the coarse estimate of the ground state energy. This technique may be applied within the framework of the Hamiltonian evolution model to enhance the process of estimating the energy of a physical system.

One purpose of employing QET-U is to transform the eigenvalues of the quantum Hamiltonian in a controlled manner, enabling the extraction of a coarse estimate of the ground state energy. This is achieved by applying a sequence of unitary transformations, parameterized by real polynomials, to the quantum state that encodes the Hamiltonian. The QET-U technique is particularly suited for early fault-tolerant quantum devices due to its reliance on a single ancilla qubit and its avoidance of multi-qubit control operations.

Benefits of QET-U include:
Precision in Energy Estimation: QET-U allows for a precise manipulation of the eigenvalues of the Hamiltonian, leading to a more accurate coarse estimate of the ground state energy.
Efficient Resource Utilization: By requiring only one ancilla qubit and avoiding complex control operations, QET-U optimizes the use of quantum resources, making it ideal for quantum computers with limited qubit availability.
Compatibility with Fault-Tolerant Quantum Computing: The simplicity of the QET-U circuit structure, which does not necessitate multi-qubit control operations, aligns well with the capabilities of early fault-tolerant quantum computers.
Streamlined Quantum Operations: The QET-U technique simplifies the quantum circuitry needed for energy estimation, as it replaces the need for more complex quantum phase estimation algorithms with a more direct approach.
Adaptability to Various Hamiltonians: QET-U is adaptable to a wide range of Hamiltonians, including those that can be efficiently decomposed into a linear combination of Pauli operators, making it a versatile tool for different quantum systems.
Enhanced Algorithmic Performance: The method benefits from the QET-U's ability to outperform previous algorithms with comparable circuit structures, providing a quadratic improvement in the dependence on the initial state overlap.

The integration of QET-U within embodiments of the present invention represent a significant advancement in the field of quantum computing for energy estimation. It combines the theoretical rigor of quantum eigenvalue transformations with the practical considerations of early fault-tolerant quantum devices, resulting in a method that is both efficient and effective in generating a coarse estimate of the ground state energy. This technique exemplifies the innovative application of quantum algorithms to solve complex problems in quantum physics and chemistry.

Alternatively, the encoding model may be a block encoding model. This model may be employed to represent the physical system's Hamiltonian within the quantum computational framework. The block encoding model is a technique for embedding a non-unitary matrix, such as the Hamiltonian of a physical system, into a higher-dimensional unitary matrix that can be manipulated on a quantum computer.

The block encoding model may be incorporated into the method to facilitate the encoding of the physical system's Hamiltonian into a form amenable to quantum computation. It provides a structured approach to represent the Hamiltonian as a submatrix of a larger unitary operator, which can then be used in quantum algorithms to estimate the ground state energy.

Benefits of the block encoding model include:
Quantum Circuit Implementation: The block encoding model allows for the systematic construction of quantum circuits that can simulate the action of the Hamiltonian on a quantum state, which is essential for estimating the ground state energy.
Algorithmic Versatility: This model is compatible with a variety of quantum algorithms, including those designed for amplitude estimation and quantum phase estimation, which are critical for accurately determining energy levels.
Resource Optimization: By embedding the Hamiltonian into a unitary matrix, the block encoding model enables the use of quantum resources in a way that optimizes the number of qubits and quantum gates required for the simulation.
Enhanced Control of Precision: The block encoding model provides a mechanism to control the precision of the Hamiltonian representation, which directly impacts the accuracy of the ground state energy estimation.
Integration with Quantum Subroutines: The unitary nature of the block encoding allows for seamless integration with other quantum subroutines, such as those used for state preparation and measurement, thereby creating a cohesive quantum algorithm.
Facilitation of Quantum Error Correction: The unitary operations resulting from block encoding are amenable to quantum error correction techniques, which are vital for maintaining the integrity of quantum computations on early fault-tolerant quantum computers.

The inclusion of the block encoding model within embodiments of the present invention offers a robust framework for encoding the Hamiltonian and performing quantum computations that estimate the ground state energy. It leverages the advantages of unitary operations in quantum mechanics to enhance the precision and efficiency of the energy estimation process. This approach is particularly beneficial for quantum systems where the Hamiltonian can be efficiently represented as a block within a larger unitary matrix, making it a valuable addition to the method's computational toolkit.

The physical system may include a molecular system. The quantum Hamiltonian may encode an electronic structure of the molecular system.

The method may further include determining an initial state that has a non-trivial overlap with the ground state of the physical system.

The quantum rejection sampling may include sampling from a probability distribution related to the coarse energy to generate a plurality of samples.

Refining the coarse estimate may include an iterative process, and the refined estimate may be obtained by averaging over multiple iterations.

The encoding of the physical system into a quantum Hamiltonian on the classical component may include the use of a basis set to represent electronic wavefunctions of the physical system.

The method may further include identifying and removing terms from the quantum Hamiltonian that have negligible impact on the ground state energy to optimize the efficiency of the quantum computation.

The quantum rejection sampling may include preparing a superposition of quantum states corresponding to potential energy values and selectively measuring states that fall within a confidence interval around the coarse estimate.

The quantum rejection sampling may include a post-selection process where only the measurement outcomes corresponding to the lower energy spectrum of the quantum Hamiltonian are retained for calculating the refined estimate.

The quantum rejection sampling may include the use of amplitude amplification techniques to increase the likelihood of sampling energy values close to the coarse estimate, thereby accelerating the convergence to the refined estimate.

The quantum rejection sampling may be performed in conjunction with a classical optimization algorithm that analyzes the distribution of sampled energies and guides the selection of samples to be included in the refined estimate.

The quantum rejection sampling may include a normalization step that adjusts the weights of the accepted samples.

Some embodiments of the present invention include a hybrid quantum-classical computer for estimating a ground state energy of a physical system, the hybrid quantum-classical computer including: a quantum component; and a classical component having a processor and a memory; the classical component further including means for encoding, on the classical component, the physical system into a quantum Hamiltonian; the quantum component including: means for generating a coarse estimate of an energy of the physical system using an encoding model applied to the quantum Hamiltonian; and means for refining the coarse estimate into a refined estimate using quantum rejection sampling.

Embodiments of the present invention addresses several key technical problems inherent in the field of quantum computing, particularly in the estimation of ground state energies of physical systems. One of the primary challenges solved by the invention is the accurate and efficient estimation of ground state energies on quantum computers that are in the early stages of fault tolerance and have limited qubit coherence times and operational gate fidelities. The invention also tackles the problem of optimizing quantum resource utilization, such as minimizing the number of qubits and quantum gates required for complex quantum simulations. Additionally, the invention provides solutions for the integration of quantum algorithms with early fault-tolerant quantum devices, which are expected to have limited capabilities compared to fully fault-tolerant quantum computers.

Embodiments of the present invention achieve several key technical effects that significantly advance the state of quantum computing, such as:
Enhanced Precision: By employing quantum rejection sampling and quantum eigenvalue transformation techniques, the invention achieves a high level of precision in estimating ground state energies, which is critical for applications in quantum chemistry and condensed matter physics.
Resource Efficiency: The invention's methods are designed to make efficient use of quantum resources, reducing the number of ancilla qubits and multi-qubit control operations required, thus making the invention practical for early fault-tolerant quantum computers.
Scalability: The techniques used in the invention are scalable to systems of varying sizes and complexities, ensuring that the invention remains applicable as quantum systems continue to evolve.
Algorithmic Versatility: The invention's methods are compatible with a range of quantum algorithms, providing flexibility in addressing different types of quantum computational problems.
Error Mitigation: By simplifying quantum operations and leveraging the natural dynamics of quantum systems, the invention inherently mitigates certain types of errors, contributing to more reliable quantum computations.

Embodiments of the present invention make several key technical contributions to the field of quantum computing, such as:
Innovative Sampling Technique: The invention introduces a novel quantum rejection sampling method that iteratively refines energy estimates, a technique that is particularly suited for quantum systems with limited qubit numbers and gate fidelities.
Quantum Eigenvalue Transformation: The invention contributes a method for implementing quantum eigenvalue transformation using real polynomials, which simplifies the quantum circuitry needed for energy estimation and is adaptable to various Hamiltonians.
Hybrid Quantum-Classical Approach: The invention effectively integrates quantum and classical computational techniques, utilizing classical optimization to guide the quantum sampling process, thereby enhancing the overall efficiency and accuracy of the quantum computations.
Fault-Tolerant Design: The invention's methods are tailored for early fault-tolerant quantum computers, addressing the specific challenges and limitations of these emerging technologies
Practical Application Enablement: By solving the aforementioned technical problems and achieving the stated technical effects, the invention enables practical applications of quantum computing in areas that require precise energy estimations, such as drug discovery and material science.

In summary, embodiments of the present invention provide a comprehensive solution to several technical challenges in quantum computing, offering enhanced precision, resource efficiency, scalability, and versatility. These technical contributions represent significant advancements in the field, enabling the practical application of quantum computing to complex scientific problems.

The advanced methods used by embodiments of the present invention for estimating ground state energies using quantum computing have several important and valuable real-world applications across various scientific and technological domains, such as:
Quantum Chemistry: In the field of quantum chemistry, precise ground state energy estimations are crucial for understanding molecular structures, reaction mechanisms, and chemical properties. The invention can significantly improve the accuracy of molecular simulations, leading to better drug design, material synthesis, and catalyst development.
Material Science: The invention can be applied to discover and design new materials with desired properties by accurately predicting the ground state energies of complex material systems. This has implications for developing more efficient semiconductors, superconductors, and nanomaterials.
Pharmaceuticals: In drug discovery, the invention can help identify stable molecular configurations and binding affinities, accelerating the development of new medications and reducing the time and cost associated with pharmaceutical research.
Energy Storage: Accurate ground state energy calculations are essential for designing better batteries and energy storage systems. The invention can contribute to the development of high-capacity, fast-charging, and long-lasting batteries for electric vehicles and renewable energy applications.
Catalysis: By providing precise energy estimations, the invention can aid in the design of more effective catalysts for industrial chemical processes, potentially leading to more environmentally friendly and cost-effective manufacturing.
Quantum Algorithm Research: The invention's methods for efficient quantum computation can advance the field of quantum algorithm research, leading to new algorithms that are optimized for early fault-tolerant quantum computers.
Cryptography: Understanding the ground state energies of quantum systems is also relevant for quantum cryptography, where the invention could contribute to the development of secure communication protocols that leverage quantum mechanical principles.
Computational Physics: The invention can be used to solve complex problems in condensed matter physics, high-energy physics, and cosmology, where accurate energy estimations are necessary for modeling and simulation.
Nanotechnology: In nanotechnology, the invention can facilitate the design and analysis of quantum dots, nanowires, and other nanostructures by providing precise energy calculations that inform their electronic and optical properties.
Artificial Intelligence: The invention's quantum computing techniques can potentially be integrated with machine learning algorithms to create powerful AI models capable of solving highly complex optimization and pattern recognition problems.

These applications demonstrate the broad impact of embodiments of the present invention, which extends beyond theoretical advancements to practical solutions that can drive innovation and progress in multiple industries and scientific fields.

One embodiment of the present invention is directed to a method for estimating a ground state energy of a physical system on a hybrid quantum-classical computer having a quantum component and a classical component. The quantum component may, for example, be a quantum device and/or a quantum computer, as those terms are used herein. The classical component may, for example, be a classical computer as that term is used herein.

The method may include: encoding, on the classical component, the physical system into a quantum Hamiltonian; generating, on the quantum component, a coarse estimate of an energy of the physical system using an encoding model applied to the quantum Hamiltonian; and refining, on the quantum component, the coarse estimate into a refined estimate using quantum rejection sampling.

The encoding model may be a Hamiltonian evolution model. The encoding model may be a block encoding model.

Generating the coarse estimate may include using a quantum eigenvalue transformation of unitary matrices with real polynomials.

The physical system may include a molecular system. The quantum Hamiltonian may encode an electronic structure of the molecular system.

The method may further include determining an initial state that has a non-trivial overlap with the ground state of the physical system.

The quantum rejection sampling may include sampling from a probability distribution related to the coarse energy to generate a plurality of samples.

Refining the coarse estimate may include an iterative process, and the refined estimate may be obtained by averaging over multiple iterations.

Encoding of the physical system into a quantum Hamiltonian on the classical component may include the use of a basis set to represent electronic wavefunctions of the physical system.

The method may further include identifying and removing terms from the quantum Hamiltonian that have negligible impact on the ground state energy to optimize the efficiency of the quantum computation.

The quantum rejection sampling may include preparing a superposition of quantum states corresponding to potential energy values and selectively measuring states that fall within a confidence interval around the coarse estimate.

The quantum rejection sampling may include a post-selection process where only the measurement outcomes corresponding to the lower energy spectrum of the quantum Hamiltonian are retained for calculating the refined estimate.

The quantum rejection sampling may include the use of amplitude amplification techniques to increase the likelihood of sampling energy values close to the coarse estimate, thereby accelerating the convergence to the refined estimate.

The quantum rejection sampling may be performed in conjunction with a classical optimization algorithm that analyzes the distribution of sampled energies and guides the selection of samples to be included in the refined estimate.

The quantum rejection sampling may include a normalization step that adjusts the weights of the accepted samples.

Another embodiment of the invention is directed to a hybrid quantum-classical computer for estimating a ground state energy of a physical system. The hybrid quantum-classical computer may include: a quantum component; and a classical component having a processor and a memory. The classical component may further include means for encoding, on the classical component, the physical system into a quantum Hamiltonian. The quantum component may include: means for generating a coarse estimate of an energy of the physical system using an encoding model applied to the quantum Hamiltonian; and means for refining the coarse estimate into a refined estimate using quantum rejection sampling.

The encoding model may be a Hamiltonian evolution model. The encoding model may be a block encoding model.

Generating the coarse estimate may include using a quantum eigenvalue transformation of unitary matrices with real polynomials.

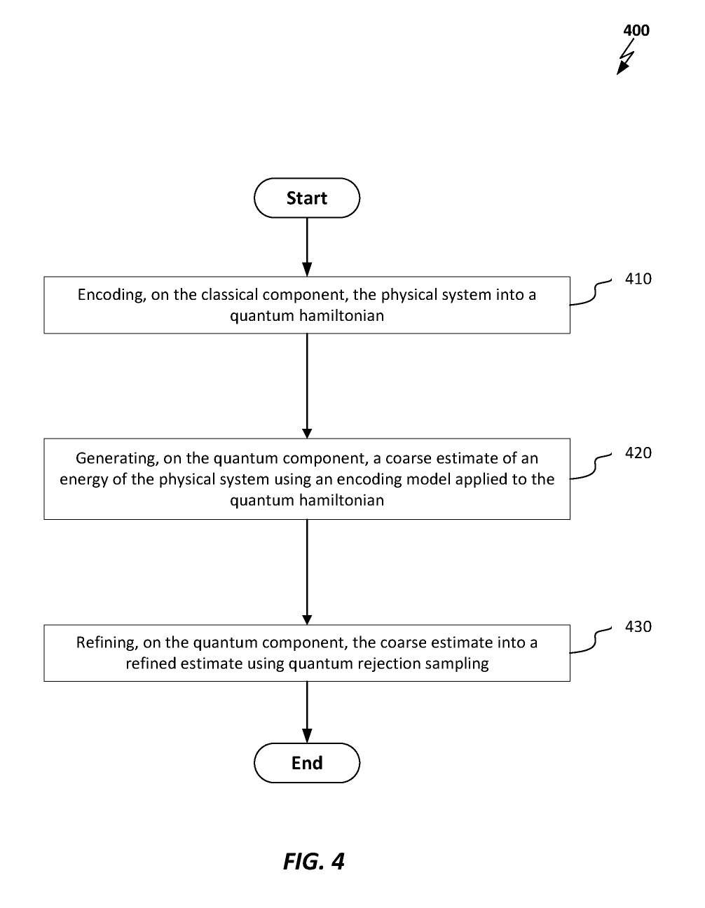

FIG. 4 is a flowchart of an example method 400 for estimating a ground state energy of a physical system on a hybrid quantum-classical computer having a quantum component and a classical component. At operation 410, the method 400 encodes, on the classical component, the physical system into a quantum Hamiltonian. At operation 420, the method 400 generates, on the quantum component, a coarse estimate of an energy of the physical system using an encoding model applied to the quantum Hamiltonian. At operation 430, the method 400 refines, on the quantum component, the coarse estimate into a refined estimate using quantum rejection sampling.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Various physical embodiments of a quantum computer are suitable for use according to the present disclosure. In general, the fundamental data storage unit in quantum computing is the quantum bit, or qubit. The qubit is a quantum-computing analog of a classical digital computer system bit. A classical bit is considered to occupy, at any given point in time, one of two possible states corresponding to the binary digits (bits) 0 or 1. By contrast, a qubit is implemented in hardware by a physical medium with quantum-mechanical characteristics. Such a medium, which physically instantiates a qubit, may be referred to herein as a “physical instantiation of a qubit,” a “physical embodiment of a qubit,” a “medium embodying a qubit,” or similar terms, or simply as a “qubit,” for ease of explanation. It should be understood, therefore, that references herein to “qubits” within descriptions of embodiments of the present invention refer to physical media which embody qubits.

Each qubit has an infinite number of different potential quantum-mechanical states. When the state of a qubit is physically measured, the measurement produces one of two different basis states resolved from the state of the qubit. Thus, a single qubit can represent a one, a zero, or any quantum superposition of those two qubit states; a pair of qubits can be in any quantum superposition of 4 orthogonal basis states; and three qubits can be in any superposition of 8 orthogonal basis states. The function that defines the quantum-mechanical states of a qubit is known as its wavefunction. The wavefunction also specifies the probability distribution of outcomes for a given measurement. A qubit, which has a quantum state of dimension two (i.e., has two orthogonal basis states), may be generalized to a d -dimensional “qudit,” where d may be any integral value, such as 2, 3, 4, or higher. In the general case of a qudit, measurement of the qudit produces one of d different basis states resolved from the state of the qudit. Any reference herein to a qubit should be understood to refer more generally to an d -dimensional qudit with any value of d .

Although certain descriptions of qubits herein may describe such qubits in terms of their mathematical properties, each such qubit may be implemented in a physical medium in any of a variety of different ways. Examples of such physical media include superconducting material, trapped ions, photons, optical cavities, individual electrons trapped within quantum dots, point defects in solids (e.g., phosphorus donors in silicon or nitrogen-vacancy centers in diamond), molecules (e.g., alanine, vanadium complexes), or aggregations of any of the foregoing that exhibit qubit behavior, that is, comprising quantum states and transitions therebetween that can be controllably induced or detected.

For any given medium that implements a qubit, any of a variety of properties of that medium may be chosen to implement the qubit. For example, if electrons are chosen to implement qubits, then the x component of its spin degree of freedom may be chosen as the property of such electrons to represent the states of such qubits. Alternatively, the y component, or the z component of the spin degree of freedom may be chosen as the property of such electrons to represent the state of such qubits. This is merely a specific example of the general feature that for any physical medium that is chosen to implement qubits, there may be multiple physical degrees of freedom (e.g., the x, y, and z components in the electron spin example) that may be chosen to represent 0 and 1. For any particular degree of freedom, the physical medium may controllably be put in a state of superposition, and measurements may then be taken in the chosen degree of freedom to obtain readouts of qubit values.

Certain implementations of quantum computers, referred to as gate model quantum computers, comprise quantum gates. In contrast to classical gates, there is an infinite number of possible single-qubit quantum gates that change the state vector of a qubit. Changing the state of a qubit state vector typically is referred to as a single-qubit rotation, and may also be referred to herein as a state change or a single-qubit quantum-gate operation. A rotation, state change, or single-qubit quantum-gate operation may be represented mathematically by a unitary 2X2 matrix with complex elements. A rotation corresponds to a rotation of a qubit state within its Hilbert space, which may be conceptualized as a rotation of the Bloch sphere. (As is well-known to those having ordinary skill in the art, the Bloch sphere is a geometrical representation of the space of pure states of a qubit.) Multi-qubit gates alter the quantum state of a set of qubits. For example, two-qubit gates rotate the state of two qubits as a rotation in the four-dimensional Hilbert space of the two qubits. (As is well-known to those having ordinary skill in the art, a Hilbert space is an abstract vector space possessing the structure of an inner product that allows length and angle to be measured. Furthermore, Hilbert spaces are complete: there are enough limits in the space to allow the techniques of calculus to be used.)

A quantum circuit may be specified as a sequence of quantum gates. As described in more detail below, the term “quantum gate,” as used herein, refers to the application of a gate control signal (defined below) to one or more qubits to cause those qubits to undergo certain physical transformations and thereby to implement a logical gate operation. To conceptualize a quantum circuit, the matrices corresponding to the component quantum gates may be multiplied together in the order specified by the gate sequence to produce a 2 n X2 n complex matrix representing the same overall state change on n qubits. A quantum circuit may thus be expressed as a single resultant operator. However, designing a quantum circuit in terms of constituent gates allows the design to conform to a standard set of gates, and thus enable greater ease of deployment. A quantum circuit thus corresponds to a design for actions taken upon the physical components of a quantum computer.

A given variational quantum circuit may be parameterized in a suitable device-specific manner. More generally, the quantum gates making up a quantum circuit may have an associated plurality of tuning parameters. For example, in embodiments based on optical switching, tuning parameters may correspond to the angles of individual optical elements.

In certain embodiments of quantum circuits, the quantum circuit includes both one or more gates and one or more measurement operations. Quantum computers implemented using such quantum circuits are referred to herein as implementing “measurement feedback.” For example, a quantum computer implementing measurement feedback may execute the gates in a quantum circuit and then measure only a subset (i.e., fewer than all) of the qubits in the quantum computer, and then decide which gate(s) to execute next based on the outcome(s) of the measurement(s). In particular, the measurement(s) may indicate a degree of error in the gate operation(s), and the quantum computer may decide which gate(s) to execute next based on the degree of error. The quantum computer may then execute the gate(s) indicated by the decision. This process of executing gates, measuring a subset of the qubits, and then deciding which gate(s) to execute next may be repeated any number of times. Measurement feedback may be useful for performing quantum error correction, but is not limited to use in performing quantum error correction. For every quantum circuit, there is an error-corrected implementation of the circuit with or without measurement feedback.

Some embodiments described herein generate, measure, or utilize quantum states that approximate a target quantum state (e.g., a ground state of a Hamiltonian). As will be appreciated by those trained in the art, there are many ways to quantify how well a first quantum state “approximates” a second quantum state. In the following description, any concept or definition of approximation known in the art may be used without departing from the scope hereof. For example, when the first and second quantum states are represented as first and second vectors, respectively, the first quantum state approximates the second quantum state when an inner product between the first and second vectors (called the “fidelity” between the two quantum states) is greater than a predefined amount (typically labeled ϵ). In this example, the fidelity quantifies how “close” or “similar” the first and second quantum states are to each other. The fidelity represents a probability that a measurement of the first quantum state will give the same result as if the measurement were performed on the second quantum state. Proximity between quantum states can also be quantified with a distance measure, such as a Euclidean norm, a Hamming distance, or another type of norm known in the art. Proximity between quantum states can also be defined in computational terms. For example, the first quantum state approximates the second quantum state when a polynomial time-sampling of the first quantum state gives some desired information or property that it shares with the second quantum state.

Not all quantum computers are gate model quantum computers. Embodiments of the present invention are not limited to being implemented using gate model quantum computers. As an alternative example, embodiments of the present invention may be implemented, in whole or in part, using a quantum computer that is implemented using a quantum annealing architecture, which is an alternative to the gate model quantum computing architecture. More specifically, quantum annealing (QA) is a metaheuristic for finding the global minimum of a given objective function over a given set of candidate solutions (candidate states), by a process using quantum fluctuations.

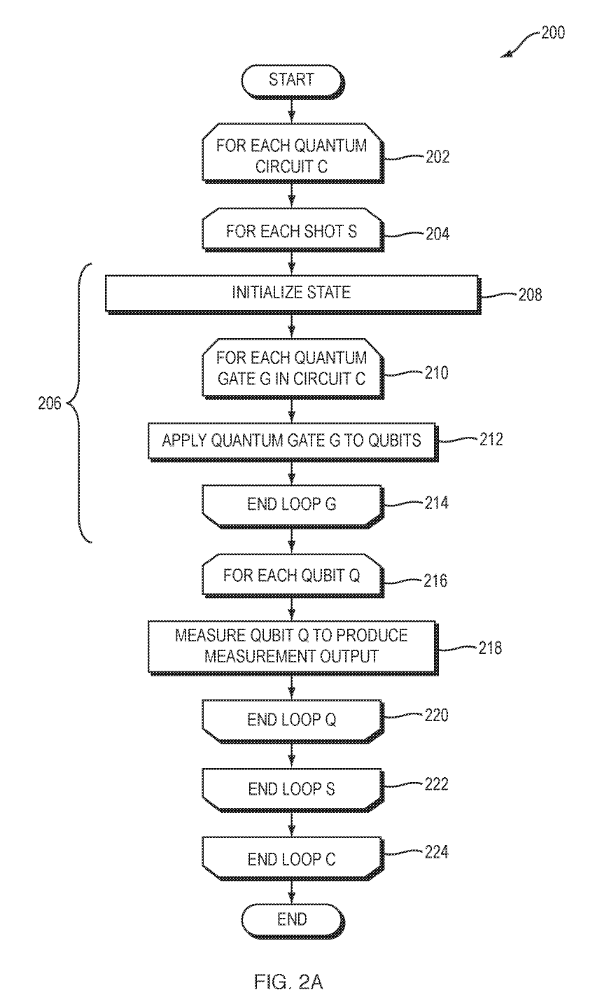

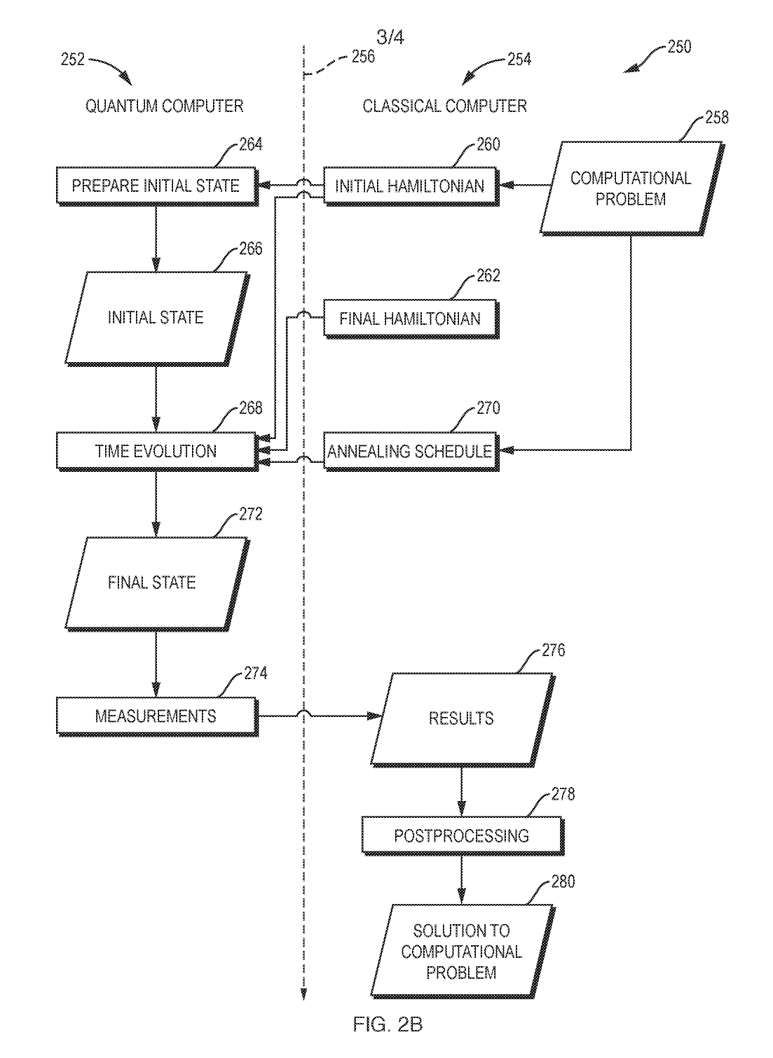

FIG. 2B shows a diagram illustrating operations typically performed by a computer system 250 which implements quantum annealing. The system 250 includes both a quantum computer 252 and a classical computer 254. Operations shown on the left of the dashed vertical line 256 typically are performed by the quantum computer 252, while operations shown on the right of the dashed vertical line 256 typically are performed by the classical computer 254.

Quantum annealing starts with the classical computer 254 generating an initial Hamiltonian 260 and a final Hamiltonian 262 based on a computational problem 258 to be solved, and providing the initial Hamiltonian 260, the final Hamiltonian 262 and an annealing schedule 270 as input to the quantum computer 252. The quantum computer 252 prepares a well-known initial state 266 (FIG. 2B, operation 264), such as a quantum-mechanical superposition of all possible states (candidate states) with equal weights, based on the initial Hamiltonian 260. The classical computer 254 provides the initial Hamiltonian 260, a final Hamiltonian 262, and an annealing schedule 270 to the quantum computer 252. The quantum computer 252 starts in the initial state 266, and evolves its state according to the annealing schedule 270 following the time-dependent Schrödinger equation, a natural quantum-mechanical evolution of physical systems (FIG. 2B, operation 268). More specifically, the state of the quantum computer 252 undergoes time evolution under a time-dependent Hamiltonian, which starts from the initial Hamiltonian 260 and terminates at the final Hamiltonian 262. If the rate of change of the system Hamiltonian is slow enough, the system stays close to the ground state of the instantaneous Hamiltonian. If the rate of change of the system Hamiltonian is accelerated, the system may leave the ground state temporarily but produce a higher likelihood of concluding in the ground state of the final problem Hamiltonian, i.e., diabatic quantum computation. At the end of the time evolution, the set of qubits on the quantum annealer is in a final state 272, which is expected to be close to the ground state of the classical Ising model that corresponds to the solution to the original computational problem 258. An experimental demonstration of the success of quantum annealing for random magnets was reported immediately after the initial theoretical proposal.

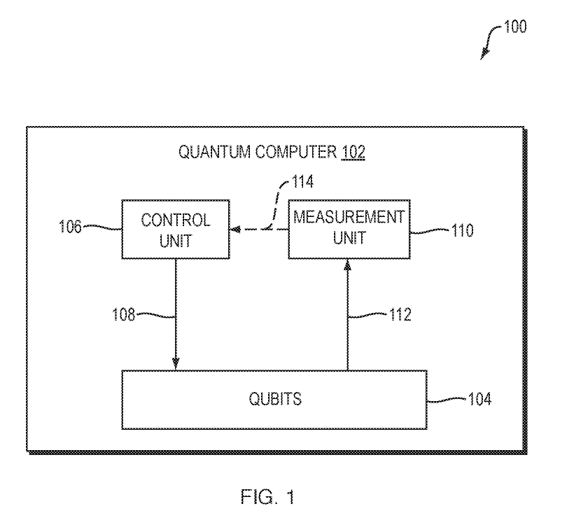

The final state 272 of the quantum computer 252 is measured, thereby producing results 276 (i.e., measurements) (FIG. 2B, operation 274). The measurement operation 274 may be performed, for example, in any of the ways disclosed herein, such as in any of the ways disclosed herein in connection with the measurement unit 110 in FIG. 1. The classical computer 254 performs postprocessing on the measurement results 276 to produce output 280 representing a solution to the original computational problem 258 (FIG. 2B, operation 278).

As yet another alternative example, embodiments of the present invention may be implemented, in whole or in part, using a quantum computer that is implemented using a one-way quantum computing architecture, also referred to as a measurement-based quantum computing architecture, which is another alternative to the gate model quantum computing architecture. More specifically, the one-way or measurement based quantum computer (MBQC) is a method of quantum computing that first prepares an entangled resource state, usually a cluster state or graph state, then performs single qubit measurements on it. It is "one-way" because the resource state is destroyed by the measurements.

The outcome of each individual measurement is random, but they are related in such a way that the computation always succeeds. In general the choices of basis for later measurements need to depend on the results of earlier measurements, and hence the measurements cannot all be performed at the same time.

Any of the functions disclosed herein may be implemented using means for performing those functions. Such means include, but are not limited to, any of the components disclosed herein, such as the computer-related components described below.

Referring to FIG. 1, a diagram is shown of a system 100 implemented according to one embodiment of the present invention. Referring to FIG. 2A, a flowchart is shown of a method 200 performed by the system 100 of FIG. 1 according to one embodiment of the present invention. The system 100 includes a quantum computer 102. The quantum computer 102 includes a plurality of qubits 104, which may be implemented in any of the ways disclosed herein. There may be any number of qubits 104 in the quantum computer 102. For example, the qubits 104 may include or consist of no more than 2 qubits, no more than 4 qubits, no more than 8 qubits, no more than 16 qubits, no more than 32 qubits, no more than 64 qubits, no more than 128 qubits, no more than 256 qubits, no more than 512 qubits, no more than 1024 qubits, no more than 2048 qubits, no more than 4096 qubits, or no more than 8192 qubits. These are merely examples, in practice there may be any number of qubits 104 in the quantum computer 102.

There may be any number of gates in a quantum circuit. However, in some embodiments the number of gates may be at least proportional to the number of qubits 104 in the quantum computer 102. In some embodiments the gate depth may be no greater than the number of qubits 104 in the quantum computer 102, or no greater than some linear multiple of the number of qubits 104 in the quantum computer 102 (e.g., 2, 3, 4, 5, 6, or 7).

The qubits 104 may be interconnected in any graph pattern. For example, they be connected in a linear chain, a two-dimensional grid, an all-to-all connection, any combination thereof, or any subgraph of any of the preceding.

As will become clear from the description below, although element 102 is referred to herein as a “quantum computer,” this does not imply that all components of the quantum computer 102 leverage quantum phenomena. One or more components of the quantum computer 102 may, for example, be classical (i.e., non-quantum components) components which do not leverage quantum phenomena.

The quantum computer 102 includes a control unit 106, which may include any of a variety of circuitry and/or other machinery for performing the functions disclosed herein. The control unit 106 may, for example, consist entirely of classical components. The control unit 106 generates and provides as output one or more control signals 108 to the qubits 104. The control signals 108 may take any of a variety of forms, such as any kind of electromagnetic signals, such as electrical signals, magnetic signals, optical signals (e.g., laser pulses), or any combination thereof.

For example:
In embodiments in which some or all of the qubits 104 are implemented as photons (also referred to as a “quantum optical” implementation) that travel along waveguides, the control unit 106 may be a beam splitter (e.g., a heater or a mirror), the control signals 108 may be signals that control the heater or the rotation of the mirror, the measurement unit 110 may be a photodetector, and the measurement signals 112 may be photons.
In embodiments in which some or all of the qubits 104 are implemented as charge type qubits (e.g., transmon, X-mon, G-mon) or flux-type qubits (e.g., flux qubits, capacitively shunted flux qubits) (also referred to as a “circuit quantum electrodynamic” (circuit QED) implementation), the control unit 106 may be a bus resonator activated by a drive, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as superconducting circuits, the control unit 106 may be a circuit QED-assisted control unit or a direct capacitive coupling control unit or an inductive capacitive coupling control unit, the control signals 108 may be cavity modes, the measurement unit 110 may be a second resonator (e.g., a low-Q resonator), and the measurement signals 112 may be voltages measured from the second resonator using dispersive readout techniques. In embodiments in which some or all of the qubits 104 are implemented as trapped ions (e.g., electronic states of, e.g., magnesium ions), the control unit 106 may be a laser, the control signals 108 may be laser pulses, the measurement unit 110 may be a laser and either a CCD or a photodetector (e.g., a photomultiplier tube), and the measurement signals 112 may be photons.
In embodiments in which some or all of the qubits 104 are implemented using nuclear magnetic resonance (NMR) (in which case the qubits may be molecules, e.g., in liquid or solid form), the control unit 106 may be a radio frequency (RF) antenna, the control signals 108 may be RF fields emitted by the RF antenna, the measurement unit 110 may be another RF antenna, and the measurement signals 112 may be RF fields measured by the second RF antenna.
In embodiments in which some or all of the qubits 104 are implemented as nitrogen-vacancy centers (NV centers), the control unit 106 may, for example, be a laser, a microwave antenna, or a coil, the control signals 108 may be visible light, a microwave signal, or a constant electromagnetic field, the measurement unit 110 may be a photodetector, and the measurement signals 112 may be photons.
In embodiments in which some or all of the qubits 104 are implemented as two-dimensional quasiparticles called “anyons” (also referred to as a “topological quantum computer” implementation), the control unit 106 may be nanowires, the control signals 108 may be local electrical fields or microwave pulses, the measurement unit 110 may be superconducting circuits, and the measurement signals 112 may be voltages.
In embodiments in which some or all of the qubits 104 are implemented as semiconducting material (e.g., nanowires), the control unit 106 may be microfabricated gates, the control signals 108 may be RF or microwave signals, the measurement unit 110 may be microfabricated gates, and the measurement signals 112 may be RF or microwave signals.

Although not shown explicitly in FIG. 1 and not required, the measurement unit 110 may provide one or more feedback signals 114 to the control unit 106 based on the measurement signals 112. For example, quantum computers referred to as “one-way quantum computers” or “measurement-based quantum computers” utilize such feedback signals 114 from the measurement unit 110 to the control unit 106. Such feedback signals 114 are also necessary for the operation of fault-tolerant quantum computing and error correction.

The control signals 108 may, for example, include one or more state preparation signals which, when received by the qubits 104, cause some or all of the qubits 104 to change their states. Such state preparation signals constitute a quantum circuit also referred to as an “ansatz circuit.” The resulting state of the qubits 104 is referred to herein as an “initial state” or an “ansatz state.” The process of outputting the state preparation signal(s) to cause the qubits 104 to be in their initial state is referred to herein as “state preparation” (FIG. 2A, section 206). A special case of state preparation is “initialization,” also referred to as a “reset operation,” in which the initial state is one in which some or all of the qubits 104 are in the “zero” state i.e. the default single-qubit state. More generally, state preparation may involve using the state preparation signals to cause some or all of the qubits 104 to be in any distribution of desired states. In some embodiments, the control unit 106 may first perform initialization on the qubits 104 and then perform preparation on the qubits 104, by first outputting a first set of state preparation signals to initialize the qubits 104, and by then outputting a second set of state preparation signals to put the qubits 104 partially or entirely into non-zero states.

Another example of control signals 108 that may be output by the control unit 106 and received by the qubits 104 are gate control signals. The control unit 106 may output such gate control signals, thereby applying one or more gates to the qubits 104. Applying a gate to one or more qubits causes the set of qubits to undergo a physical state change which embodies a corresponding logical gate operation (e.g., single-qubit rotation, two-qubit entangling gate or multi-qubit operation) specified by the received gate control signal. As this implies, in response to receiving the gate control signals, the qubits 104 undergo physical transformations which cause the qubits 104 to change state in such a way that the states of the qubits 104, when measured (see below), represent the results of performing logical gate operations specified by the gate control signals. The term “quantum gate,” as used herein, refers to the application of a gate control signal to one or more qubits to cause those qubits to undergo the physical transformations described above and thereby to implement a logical gate operation.

It should be understood that the dividing line between state preparation (and the corresponding state preparation signals) and the application of gates (and the corresponding gate control signals) may be chosen arbitrarily. For example, some or all the components and operations that are illustrated in FIGS. 1 and 2A-2B as elements of “state preparation” may instead be characterized as elements of gate application. Conversely, for example, some or all of the components and operations that are illustrated in FIGS. 1 and 2A-2B as elements of “gate application” may instead be characterized as elements of state preparation. As one particular example, the system and method of FIGS. 1 and 2A-2B may be characterized as solely performing state preparation followed by measurement, without any gate application, where the elements that are described herein as being part of gate application are instead considered to be part of state preparation. Conversely, for example, the system and method of FIGS. 1 and 2A-2B may be characterized as solely performing gate application followed by measurement, without any state preparation, and where the elements that are described herein as being part of state preparation are instead considered to be part of gate application.

The quantum computer 102 also includes a measurement unit 110, which performs one or more measurement operations on the qubits 104 to read out measurement signals 112 (also referred to herein as “measurement results”) from the qubits 104, where the measurement results 112 are signals representing the states of some or all of the qubits 104. In practice, the control unit 106 and the measurement unit 110 may be entirely distinct from each other, or contain some components in common with each other, or be implemented using a single unit (i.e., a single unit may implement both the control unit 106 and the measurement unit 110). For example, a laser unit may be used both to generate the control signals 108 and to provide stimulus (e.g., one or more laser beams) to the qubits 104 to cause the measurement signals 112 to be generated.

In general, the quantum computer 102 may perform various operations described above any number of times. For example, the control unit 106 may generate one or more control signals 108, thereby causing the qubits 104 to perform one or more quantum gate operations. The measurement unit 110 may then perform one or more measurement operations on the qubits 104 to read out a set of one or more measurement signals 112. The measurement unit 110 may repeat such measurement operations on the qubits 104 before the control unit 106 generates additional control signals 108, thereby causing the measurement unit 110 to read out additional measurement signals 112 resulting from the same gate operations that were performed before reading out the previous measurement signals 112. The measurement unit 110 may repeat this process any number of times to generate any number of measurement signals 112 corresponding to the same gate operations. The quantum computer 102 may then aggregate such multiple measurements of the same gate operations in any of a variety of ways.

After the measurement unit 110 has performed one or more measurement operations on the qubits 104 after they have performed one set of gate operations, the control unit 106 may generate one or more additional control signals 108, which may differ from the previous control signals 108, thereby causing the qubits 104 to perform one or more additional quantum gate operations, which may differ from the previous set of quantum gate operations. The process described above may then be repeated, with the measurement unit 110 performing one or more measurement operations on the qubits 104 in their new states (resulting from the most recently-performed gate operations).

In general, the system 100 may implement a plurality of quantum circuits as follows. For each quantum circuit C in the plurality of quantum circuits (FIG. 2A, operation 202), the system 100 performs a plurality of “shots” on the qubits 104. The meaning of a shot will become clear from the description that follows. For each shot S in the plurality of shots (FIG. 2A, operation 204), the system 100 prepares the state of the qubits 104 (FIG. 2A, section 206). More specifically, for each quantum gate G in quantum circuit C (FIG. 2A, operation 210), the system 100 applies quantum gate G to the qubits 104 (FIG. 2A, operations 212 and 214).

Then, for each of the qubits Q 104 (FIG. 2A, operation 216), the system 100 measures the qubit Q to produce measurement output representing a current state of qubit Q (FIG. 2A, operations 218 and 220).

The operations described above are repeated for each shot S (FIG. 2A, operation 222), and circuit C (FIG. 2A, operation 224). As the description above implies, a single “shot” involves preparing the state of the qubits 104 and applying all of the quantum gates in a circuit to the qubits 104 and then measuring the states of the qubits 104; and the system 100 may perform multiple shots for one or more circuits.

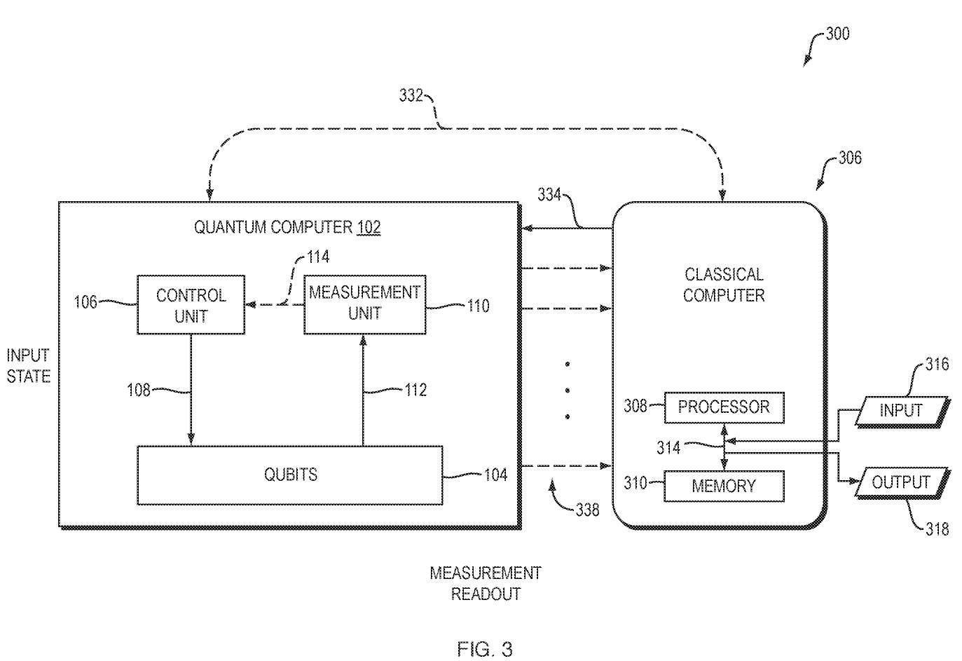

Referring to FIG. 3, a diagram is shown of a hybrid quantum classical (HQC) computer 300 implemented according to one embodiment of the present invention. The HQC 300 includes a quantum computer component 102 (which may, for example, be implemented in the manner shown and described in connection with FIG. 1) and a classical computer component 306. The classical computer component may be a machine implemented according to the general computing model established by John Von Neumann, in which programs are written in the form of ordered lists of instructions and stored within a classical (e.g., digital) memory 310 and executed by a classical (e.g., digital) processor 308 of the classical computer. The memory 310 is classical in the sense that it stores data in a storage medium in the form of bits, which have a single definite binary state at any point in time. The bits stored in the memory 310 may, for example, represent a computer program. The classical computer component 304 typically includes a bus 314. The processor 308 may read bits from and write bits to the memory 310 over the bus 314. For example, the processor 308 may read instructions from the computer program in the memory 310, and may optionally receive input data 316 from a source external to the computer 302, such as from a user input device such as a mouse, keyboard, or any other input device. The processor 308 may use instructions that have been read from the memory 310 to perform computations on data read from the memory 310 and/or the input 316, and generate output from those instructions. The processor 308 may store that output back into the memory 310 and/or provide the output externally as output data 318 via an output device, such as a monitor, speaker, or network device.

The quantum computer component 102 may include a plurality of qubits 104, as described above in connection with FIG. 1. A single qubit may represent a one, a zero, or any quantum superposition of those two qubit states. The classical computer component 304 may provide classical state preparation signals 332 to the quantum computer 102, in response to which the quantum computer 102 may prepare the states of the qubits 104 in any of the ways disclosed herein, such as in any of the ways disclosed in connection with FIGS. 1 and 2A-2B.

Once the qubits 104 have been prepared, the classical processor 308 may provide classical control signals 334 to the quantum computer 102, in response to which the quantum computer 102 may apply the gate operations specified by the control signals 332 to the qubits 104, as a result of which the qubits 104 arrive at a final state. The measurement unit 110 in the quantum computer 102 (which may be implemented as described above in connection with FIGS. 1 and 2A-2B) may measure the states of the qubits 104 and produce measurement output 338 representing the collapse of the states of the qubits 104 into one of their eigenstates. As a result, the measurement output 338 includes or consists of bits and therefore represents a classical state. The quantum computer 102 provides the measurement output 338 to the classical processor 308. The classical processor 308 may store data representing the measurement output 338 and/or data derived therefrom in the classical memory 310.

The steps described above may be repeated any number of times, with what is described above as the final state of the qubits 104 serving as the initial state of the next iteration. In this way, the classical computer 304 and the quantum computer 102 may cooperate as co-processors to perform joint computations as a single computer system.

Although certain functions may be described herein as being performed by a classical computer and other functions may be described herein as being performed by a quantum computer, these are merely examples and do not constitute limitations of the present invention. A subset of the functions which are disclosed herein as being performed by a quantum computer may instead be performed by a classical computer. For example, a classical computer may execute functionality for emulating a quantum computer and provide a subset of the functionality described herein, albeit with functionality limited by the exponential scaling of the simulation. Functions which are disclosed herein as being performed by a classical computer may instead be performed by a quantum computer.

The techniques described above may be implemented, for example, in hardware, in one or more computer programs tangibly stored on one or more computer-readable media, firmware, or any combination thereof, such as solely on a quantum computer, solely on a classical computer, or on a hybrid quantum classical (HQC) computer. The techniques disclosed herein may, for example, be implemented solely on a classical computer, in which the classical computer emulates the quantum computer functions disclosed herein.

Any reference herein to the state |0 ⟩ may alternatively refer to the state |1 ⟩ , and vice versa. In other words, any role described herein for the states |0 ⟩ and |1 ⟩ may be reversed within embodiments of the present invention. More generally, any computational basis state disclosed herein may be replaced with any suitable reference state within embodiments of the present invention.

The techniques described above may be implemented in one or more computer programs executing on (or executable by) a programmable computer (such as a classical computer, a quantum computer, or an HQC) including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention leverage advanced quantum computational processes, such as the execution of complex quantum algorithms, the manipulation of quantum states through controlled unitary operations, and the iterative refinement of energy estimates using quantum rejection sampling. These features necessitate the use of a quantum computer due to the inherently quantum mechanical nature of the operations, which involve superposition, entanglement, and the probabilistic interpretation of quantum measurement outcomes. The computational tasks performed by the method, including the encoding of the quantum Hamiltonian using block encoding or Hamiltonian evolution models, the application of quantum eigenvalue transformation with real polynomials, and the precise control of quantum gate sequences for sampling and measurement, are beyond the scope of human mental capabilities and cannot be replicated manually. These processes require the speed, precision, and parallel processing abilities of a quantum computer to solve complex problems with a level of efficiency and accuracy unattainable through mental or manual methods.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

In embodiments in which a classical computing component executes a computer program providing any subset of the functionality within the scope of the claims below, the computer program may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor, which may be either a classical processor or a quantum processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A classical computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium (such as a classical computer-readable medium, a quantum computer-readable medium, or an HQC computer-readable medium). Embodiments of the invention may store such data in such data structure(s) and read such data from such data structure(s).

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A method for estimating a ground state energy of a physical system on a hybrid quantum-classical computer having a quantum component and a classical component, the method comprising:
encoding, on the classical component, the physical system into a quantum Hamiltonian;
generating, on the quantum component, a coarse estimate of an energy of the physical system using an encoding model applied to the quantum Hamiltonian; and
refining, on the quantum component, the coarse estimate into a refined estimate using quantum rejection sampling.

2. The method of claim 1, wherein the encoding model is a Hamiltonian evolution model.

3. The method of claim 1, wherein the encoding model is a block encoding model.

4. The method of claim 2, wherein generating the coarse estimate includes using a quantum eigenvalue transformation of unitary matrices with real polynomials.

5. The method of claim 1, wherein the physical system comprises a molecular system.

6. The method of claim 5, wherein the quantum Hamiltonian encodes an electronic structure of the molecular system.

7. The method of claim 1, further comprising determining an initial state that has a non-trivial overlap with the ground state of the physical system.

8. The method of claim 1, wherein the quantum rejection sampling includes sampling from a probability distribution related to the coarse energy to generate a plurality of samples.

9. The method of claim 1, wherein the refining the coarse estimate includes an iterative process, and the refined estimate is obtained by averaging over multiple iterations.

10. The method of claim 1, wherein the encoding of the physical system into a quantum Hamiltonian on the classical component includes the use of a basis set to represent electronic wavefunctions of the physical system.

11. The method of claim 1, further comprising:
identifying and removing terms from the quantum Hamiltonian that have negligible impact on the ground state energy to optimize the efficiency of the quantum computation.

12. The method of claim 1, wherein the quantum rejection sampling includes preparing a superposition of quantum states corresponding to potential energy values and selectively measuring states that fall within a confidence interval around the coarse estimate.

13. The method of claim 1, wherein the quantum rejection sampling includes a post-selection process where only the measurement outcomes corresponding to the lower energy spectrum of the quantum Hamiltonian are retained for calculating the refined estimate.

14. The method of claim 1, wherein the quantum rejection sampling includes the use of amplitude amplification techniques to increase the likelihood of sampling energy values close to the coarse estimate, thereby accelerating the convergence to the refined estimate.

15. The method of claim 1, wherein the quantum rejection sampling is performed in conjunction with a classical optimization algorithm that analyzes the distribution of sampled energies and guides the selection of samples to be included in the refined estimate.

16. The method of claim 1, wherein the quantum rejection sampling includes a normalization step that adjusts the weights of the accepted samples.

17. A hybrid quantum-classical computer for estimating a ground state energy of a physical system, the hybrid quantum-classical computer comprising:
a quantum component; and
a classical component having a processor and a memory;
the classical component further comprising means for encoding, on the classical component, the physical system into a quantum Hamiltonian;
the quantum component comprising:
means for generating a coarse estimate of an energy of the physical system using an encoding model applied to the quantum Hamiltonian; and
means for refining the coarse estimate into a refined estimate using quantum rejection sampling.

18. The hybrid quantum-classical computer of claim 17, wherein the encoding model is a Hamiltonian evolution model.

19. The hybrid quantum-classical computer of claim 17, wherein the encoding model is a block encoding model.

20. The hybrid quantum-classical computer of claim 18, wherein generating the coarse estimate includes using a quantum eigenvalue transformation of unitary matrices with real polynomials.
